(19) United States
(12) Patent Application Publication
(10) Pub. No.: US 2025/0114875 A1
(43) Pub. Date: Apr. 10, 2025

(54) LASER PROCESSING METHOD, SUBSTRATE MANUFACTURING METHOD, AND LASER PROCESSING MACHINE

(71) Applicant: DISCO CORPORATION, Tokyo (JP)

(72) Inventors: Yuki OGAWA, Tokyo (JP); Kazuki MORI, Tokyo (JP); Yuya SETO, Tokyo (JP)

(21) Appl. No.: 18/887,683

(22) Filed: Sep. 17, 2024

(30) Foreign Application Priority Data
Oct. 4, 2023 (JP) 2023-172906

(51) Int. Cl. B23K 26/53; B23K 26/03; B23K 103/00

(52) U.S. Cl. CPC B23K 26/53; B23K 26/032; B23K 2103/56

(57) ABSTRACT

A laser processing method for forming a separation layer inside an ingot by using a laser beam includes a manufacturing a substrate by separating a portion of the ingot, the portion being located on a side of one side of the ingot, then evaluating the substrate to acquire information on optical characteristics in each of a plurality of regions on the one side of the ingot, then setting, for every one of the plurality of regions, irradiation conditions for the laser beam with reference to the information, and then forming the separation layer inside the ingot by irradiating the ingot with the laser beam from the one side with a focal point at which the laser beam is focused inside of the ingot.

### BACKGROUND OF THE INVENTION

### Field of the Invention

The present invention relates to a laser processing method for forming a separation layer inside an ingot by using a laser beam of a wavelength having transmissivity for a material of the ingot, a substrate manufacturing method for manufacturing a substrate from the ingot by using the laser beam, and also to a laser processing machine for forming the separation layer inside the ingot by using the laser beam.

### Description of the Related Art

Chips of semiconductor devices are generally manufactured using disk-shaped substrates. Such substrates are manufactured by being sliced from a cylindrical semiconductor ingot, for example, by using a wire saw. If substrates are manufactured in this manner, however, a majority of the ingot is wasted as a kerf loss (cutting allowance), leading to an increase in the cost of chips to be manufactured from the substrates.

Moreover, single-crystal silicon carbide (SiC) employed as a material for power devices has high hardness. Accordingly, the slicing of substrates from a single-crystal SiC ingot by using a wire saw tends to need a longer time. As a consequence, the through-put tends to decrease when manufacturing the substrates from the ingot.

In view of these shortcomings, a method has been proposed to manufacture substrates from an ingot by using a laser beam (see, for example, Japanese Patent Laid-open No. 2016-111143). In this method, the ingot is irradiated with a laser beam of a wavelength, which has transmissivity for the material of the ingot, such that a focal point, at which the laser beam is focused, is positioned inside the ingot.

As a consequence, a separation layer, which includes modified portions and cracks spreading from the modified portions, is formed inside the ingot. When an external force is applied to the ingot with the separation layer formed therein, these cracks spread further. As a result, the ingot is allowed to undergo cleavage in the separation layer, and hence, a substrate is manufactured.

### SUMMARY OF THE INVENTION

In general, a dopant such as nitrogen is doped in an ingot to impart electrical conductivity. However, the ingot may not be uniformly doped with such a dopant and may include a plurality of regions of different dopant concentrations.

For example, a region which is formed in the course of growth of single-crystal SiC, is called a “facet region,” and is flat at the atomic level is higher in dopant concentration than the remaining region (non-facet region). Further, a region having a high dopant concentration like the facet region has a high absorption rate of a laser beam, in other words, low transmissivity for a laser beam compared with the non-facet region.

If a separation layer is formed by irradiating an ingot, which has a facet region and a non-facet region, with a laser beam under fixed irradiation conditions, variations occur in the distribution of modified portions and cracks in the separation layer. Described specifically, the concentrations of modified portions and cracks become relatively low in the facet region included in the ingot.

In this case, it is difficult to allow the separation layer to undergo cleavage in the facet layer even if an external force is applied to the ingot. Even if the ingot is successfully allowed to undergo cleavage in the separation layer, the substrate so manufactured tends to have large irregularity at a surface (separated surface) of the manufactured substrate, the surface being on a side where the substrate has been separated from the ingot. If this is the case, the substrate therefore needs to be removed in a great volume so as to be planarized at the separated surface thereof, leading to an increase in the cost of chips to be manufactured from the substrate.

With the foregoing shortcomings in view, the present invention has, as objects thereof, the provision of a laser processing method and a laser processing machine that can form a separation layer, which is appropriate for allowing an ingot to undergo cleavage, inside the ingot, and a substrate manufacturing method that can manufacture a substrate from the ingot by allowing the ingot to undergo cleavage in the separation layer.

In accordance with a first aspect of the present invention, there is provided a laser processing method for forming a separation layer inside an ingot by using a laser beam of a wavelength having transmissivity for a material of the ingot, including a substrate manufacturing step of manufacturing a substrate by separating a portion of the ingot, the portion being located on a side of one side of the ingot, from the ingot, a substrate evaluating step of, after the substrate manufacturing step, evaluating the substrate to acquire information on optical characteristics in each of a plurality of regions on the side of the one side of the ingot, a setting step of, after the substrate evaluating step, setting, for every one of the plurality of regions, irradiation conditions for the laser beam with reference to the information, and a separation layer forming step of, after the setting step, forming the separation layer inside the ingot by irradiating the ingot with the laser beam from the side of the one side with a focal point at which the laser beam is focused positioned inside the ingot.

Preferably, with the substrate irradiated with light, luminance of the light transmitted through the substrate may be measured in the substrate evaluating step.

In accordance with a second aspect of the present invention, there is provided a substrate manufacturing method for manufacturing substrates from an ingot by using a laser beam of a wavelength having transmissivity for a material of the ingot, including a first-substrate manufacturing step of manufacturing a first substrate by separating a portion of the ingot, the portion being located on a side of one side of the ingot, from the ingot, a first-substrate evaluating step of, after the first-substrate manufacturing step, evaluating the first substrate to acquire information on optical characteristics in each of a plurality of regions on the side of the one side of the ingot, a setting step of, after the first-substrate evaluating step, setting, for every one of the plurality of regions, irradiation conditions for the laser beam with reference to the information, a separation layer forming step of, after the setting step, forming a separation layer inside the ingot by irradiating the ingot with the laser beam from the side of the one side with a focal point at which the laser beam is focused positioned inside the ingot, and a second-substrate manufacturing step of, after the separation layer forming step, manufacturing a second substrate by allowing the ingot to undergo cleavage in the separation layer.

In accordance with a third aspect of the present invention, there is provided a laser processing machine for forming a separation layer inside an ingot by using a laser beam of a wavelength having transmissivity for a material of the ingot, including a holding table configured to hold the ingot thereon, a laser beam irradiation unit configured to irradiate the ingot held on the holding table with the laser beam from a side of one side of the ingot, and a controller configured to control the laser beam irradiation unit. The controller has a memory configured to store information on optical characteristics and irradiation conditions for the laser beam in association with each other, and a processor configured to control the laser beam irradiation unit in such a manner that, after setting the irradiation conditions for every one of a plurality of regions for the formation of the separation layer inside the ingot with reference to information on optical characteristics acquired by evaluation of a substrate manufactured by separating a portion of the ingot, the portion being located on the side of the one side of the ingot, from the ingot, the every one of the plurality of regions is irradiated with the laser beam according to the irradiation conditions set for every one of the plurality of regions.

Preferably, the laser processing machine may further include a separation unit configured to manufacture the substrate by allowing the ingot to undergo cleavage in the separation layer.

In the present invention, with reference to the information on the optical characteristics in every one of the plurality of regions on the side of the one side of the ingot, the irradiation conditions for the laser beam for forming the separation layer inside the ingot are set for every one of the plurality of regions. In the present invention, it is hence possible to appropriately form the separation layer in the ingot.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1A is a front view schematically depicting an example of an ingot for use in manufacturing substrates;

FIG. 1B is a top plan view schematically depicting the ingot of FIG. 1A;

FIG. 2 is a flow chart schematically illustrating a laser processing method according to an embodiment of the first aspect of the present invention;

FIG. 3 is a side view schematically depicting how a substrate evaluating step of the laser processing method is conducted;

FIG. 4 is a diagram schematically presenting an example of an image formed in the substrate evaluating step;

FIG. 5 is a perspective view schematically depicting a laser processing machine according to an embodiment of the third aspect of the present invention;

FIG. 6 is a diagram schematically presenting how a pulsed laser beam advances inside the laser processing machine;

FIG. 7 is a flow chart schematically illustrating a substrate manufacturing method according to an embodiment of the second aspect of the present invention;

FIG. 8A is a side view schematically depicting a suction plate in contact at a lower surface thereof with one side of the ingot, in which a separation layer has been formed for use in manufacture of a second substrate, in a second-substrate manufacturing step of the substrate manufacturing method; and

FIG. 8B is a side view schematically depicting the second substrate separated from the ingot and held by suction on the suction plate in the second-substrate manufacturing step.

### DETAILED DESCRIPTION OF THE PREFERRED EMBODIMENTS

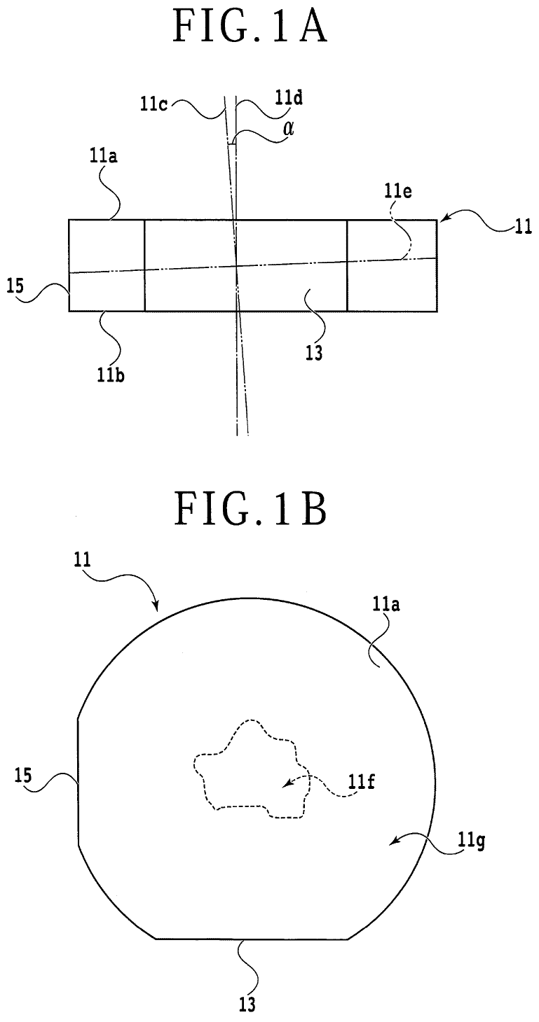

With reference to the attached drawings, a description will be made about embodiments of the first to third aspects of the present invention. FIG. 1A is a front view schematically depicting an example of an ingot 11 for use in manufacturing substrates, and FIG. 1B is a top plan view schematically depicting the ingot 11 of FIG. 1A.

The ingot 11 depicted in FIGS. 1A and 1B is formed, for example, of a cylindrical single-crystal SiC having an upper surface (one side) 11a and a lower surface (the other side) 11b, which are substantially parallel to each other. This ingot 11 is manufactured, for example, using epitaxial growth such that a c-axis 11c of the single-crystal SiC is slightly tilted with respect to a normal 11d to the one side 11a and the other side 11b.

It is to be noted that an angle (off angle) α formed between the c-axis 11c and the normal 11d is, for example, 1° to 6° (typically, 4°). On a side surface of the ingot 11, two flat portions, specifically, a primary orientation flat 13 and a secondary orientation flat 15, are formed to indicate crystal orientations of the single-crystal SiC.

The first orientation flat 13 is longer than the second orientation flat 15. Further, the second orientation flat 15 is formed such that it extends parallel to a cross line where a plane parallel to a c-plane 11e of the single-crystal SiC and the one side 11a or the other side 11b cross.

The ingot 11 is doped with a dopant such as nitrogen to impart electrical conductivity. In the ingot 11, a facet region 11f and a non-facet region 11g are included. The facet region 11f is a region which is flat at the atomic level, whereas the non-facet region 11g is a region other than the facet region 11f.

The facet region 11f is higher in dopant concentration than the non-facet region 11g. In FIG. 1B, a boundary between the facet region 11f and the non-facet region 11g is indicated by a dashed line, although this boundary line is an imaginary line, and therefore does not exist in the actual ingot 11.

The material of the ingot 11 is not limited to single-crystal SiC and may be another semiconductor, for example, such as single-crystal silicon (Si). As an alternative, the material of the ingot 11 may be lithium tantalate (LT; LiTaO₃) or gallium nitride (GaN).

One of or both the primary orientation flat 13 and the secondary orientation flat 15 may not be formed on the side surface of the ingot 11. As an alternative, instead of the primary orientation flat 13 and the secondary orientation flat 15, a notch may be formed in the side surface of the ingot 11.

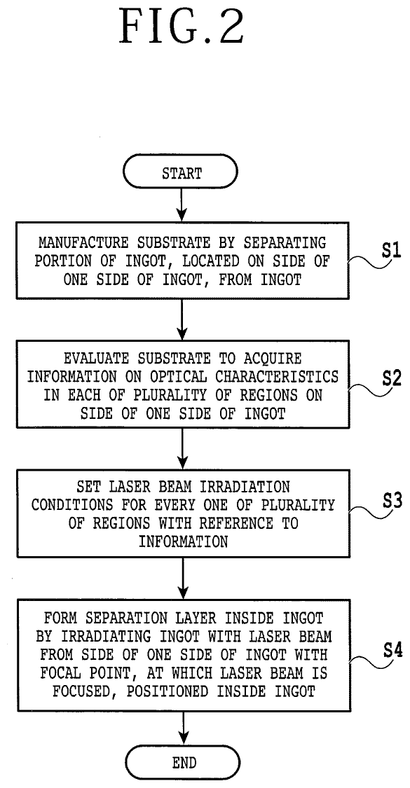

FIG. 2 is a flow chart schematically illustrating a laser processing method according to an embodiment of the first aspect of the present invention. The laser processing method forms a separation layer inside the ingot 11 by using a laser beam of a wavelength having transmissivity for the material of the ingot 11. In this laser processing method, a substrate is first manufactured by separating a portion of the ingot 11, the portion being located on a side of the one side 11a of the ingot 11, from the ingot 11 (substrate manufacturing step S1).

In this substrate manufacturing step S1, the substrate is manufactured by slicing the portion of the ingot 11, the portion being located on the side of the one side 11a of the ingot 11, by using, for example, a wire saw. As an alternative, the substrate may be manufactured in this substrate manufacturing step S1 by forming a separation layer inside the ingot 11 with use of a laser beam of a wavelength having transmissivity for the material of the ingot 11, and then allowing the ingot 11 to undergo cleavage in the separation layer.

It is to be noted that, to a surface (separated surface) of the substrate manufactured in the substrate manufacturing step S1, the surface being on a side where the substrate has been separated from the ingot 11, grinding, polishing, and/or the like may be applied to planarize the separated surface. Similarly, to the one side 11a of the ingot 11, the one side having been newly formed after the manufacture of the substrate, in other words, to a surface (exposed surface) newly exposed accompanying the manufacture of the substrate, grinding, polishing, and/or the like may be applied to planarize the exposed surface.

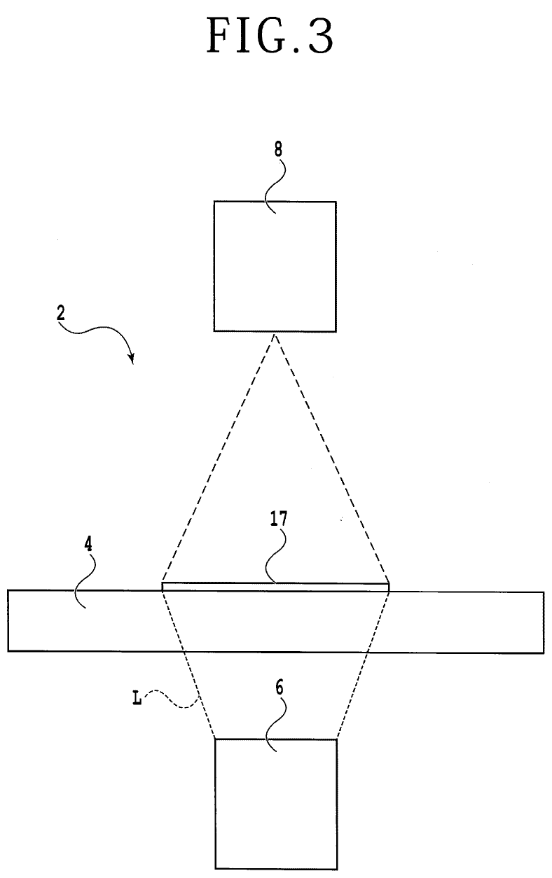

After the substrate manufacturing step S1, the substrate is evaluated to acquire information on optical characteristics in each of a plurality of regions on the side of the one side 11a of the ingot 11 (substrate evaluating step S2). FIG. 3 is a side view schematically depicting how the substrate evaluating step S2 is conducted. This substrate evaluating step S2 is conducted, for example, in an evaluation system 2 depicted in FIG. 3.

The evaluation system 2 has a table 4, a light source 6 disposed below the table 4, and a camera 8 so disposed above the table 4 that the camera 8 faces the light source 6 with the table 4 interposed therebetween. This table 4 is made from a material through which light L, such as visible light, emitted upward from the light source 6 is allowed to transmit, for example, glass or the like.

When conducting the substrate evaluating step S2 in the evaluation system 2, a substrate 17, which has been manufactured in the substrate manufacturing step S1 and may hereinafter be also called “the first substrate 17,” is first placed on the table 4 such that the substrate 17 is positioned between the light source 6 and the camera 8. With the light L emitted upward from the light source 6, the camera 8 then images the substrate 17.

This means that an image is formed based on the light L transmitted through the substrate 17. Described specifically, the camera 8 measures the luminance level of the light L in every one of the plurality of regions (specifically, a facet region 17a and a non-facet region 17b) included in the substrate 17, creates luminance data, and then forms an image based on the luminance data.

As an alternative, the camera 8 may form a binarized image based on luminance levels of the light L as measured in every one of the plurality of regions, specifically, an image in which regions where measured luminance levels of the light L are higher than a luminance level as a threshold are presented, for example, in a white color, and regions where measured luminance levels of the light L are lower than the luminance level as the threshold are presented, for example, in a black color.

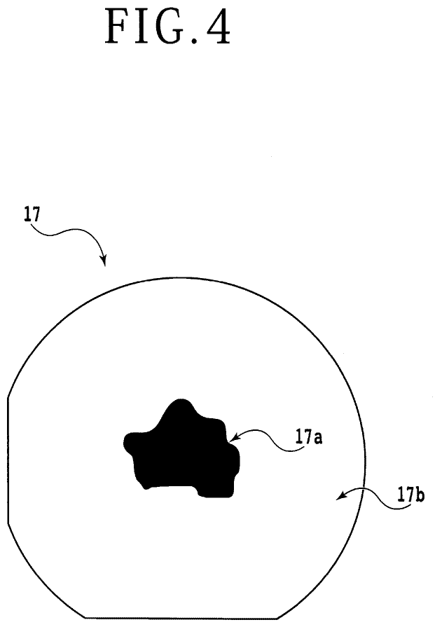

FIG. 4 is a diagram schematically presenting an example of the binarized image. Described specifically, in this case, an image is formed, in which the facet region 17a of the substrate 17, the facet region 17a being lower in the measured transmittance level of the light L than the non-facet region 17b, is presented black, while the non-facet region 17b is presented white.

As an alternative, the camera 8 may form a multi-valued image based on the luminance levels of the light L as measured in every one of the plurality of regions, specifically, an image in which the plurality of regions are each presented in one of colors classified in multiple shades (specifically, three shades or more) according to the measured luminance levels of the light L.

The arrangement of the plurality of regions (specifically, the facet region 17a and the non-facet region 17b) in the substrate 17 corresponds to that of the plurality of regions (specifically, the facet region 11f and the non-facet region 11g) on the side of the one side 11a of the ingot 11.

In the substrate evaluating step S2, it is therefore possible to acquire information on optical characteristics in every one of the plurality of regions on the side of the one side 11a of the ingot 11 (specifically, the data of the luminance level of the light L transmitted through each of the facet region 17a and the non-facet region 17b).

It is to be noted that, in the substrate evaluating step S2, the luminance of the light L reflected by the substrate 17 may be measured instead of the measurement of the luminance of the light L transmitted through the substrate 17. In this case, the imaging of the substrate 17 by the camera 8 is conducted, for example, with light L directed toward the substrate 17 from a light source 6 positioned on the same side as the camera 8 as seen from the substrate 17.

After the substrate evaluating step S2, irradiation conditions for the laser beam with which the ingot 11 is to be irradiated are set for every one of the plurality of regions on the side of the one side 11a of the ingot 11 with reference to the information acquired in the substrate evaluating step S2 (setting step S3), and then the ingot 11 is irradiated with the laser beam from the side of the one side 11a of the ingot 11 under the above-described irradiation conditions with a focal point, at which the laser beam is focused, positioned inside the ingot 11, thereby forming a separation layer inside the ingot 11 (separation layer forming step S4).

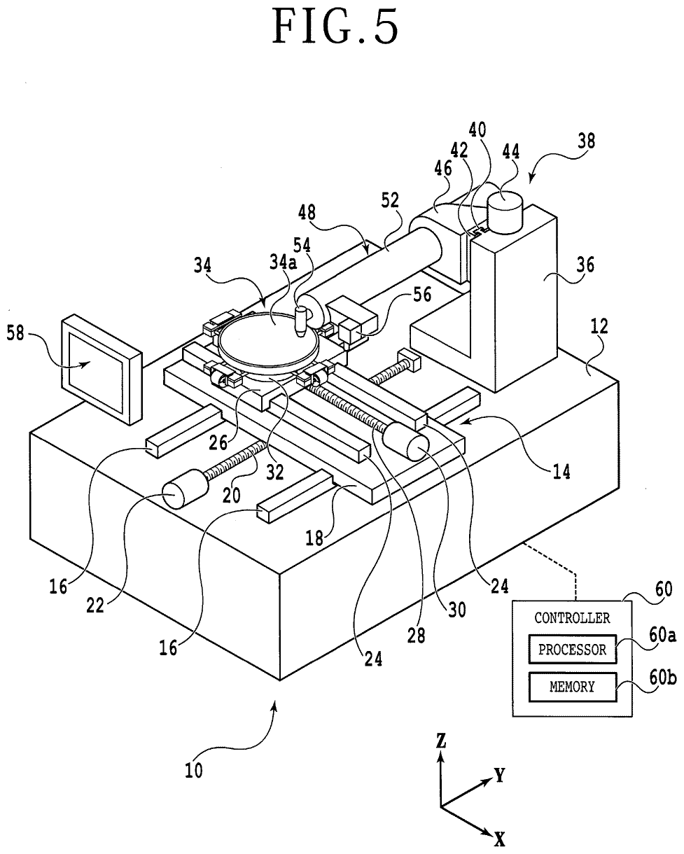

The setting step S3 and the separation layer forming step S4 are conducted, for example, on a laser processing machine 10 depicted in FIG. 5. Described specifically, the setting step S3 is conducted at a controller 60 built in the laser processing machine 10, and the separation layer forming step S4 is conducted through control of a laser beam irradiation unit 48, etc., which are disposed in the laser processing machine 10, by the controller 60.

An X-axis direction and a Y-axis direction indicated in FIG. 5 are directions orthogonal to each other on a horizontal plane, and a Z-axis direction also indicated in FIG. 5 is a direction (vertical direction) orthogonal to the X-axis direction and the Y-axis direction. In FIG. 5, some elements of the laser processing machine 10 are presented as blocks.

The laser processing machine 10 has a bed 12 that supports individual elements. On an upper surface of the bed 12, a horizontal moving mechanism 14 is arranged. The horizontal moving mechanism 14 is fixed on the upper surface of the bed 12 and has a pair of Y-axis guide rails 16 extending along the Y-axis direction.

To upper parts of the paired Y-axis guide rails 16, a Y-axis moving plate 18 is connected in such a manner that the Y-axis moving plate 18 is slidable along the paired Y-axis guide rails 16. Between the paired Y-axis guide rails 16, a screw shaft 20 is arranged extending along the Y-axis direction. To one end portion of the screw shaft 20, a motor 22 is connected to rotate the screw shaft 20.

On a surface of the screw shaft 20 in which a helical groove is formed, there is disposed a nut (not depicted) that accommodates balls rolling in the groove of the screw shaft 20, whereby a ball screw is constituted. When the screw shaft 20 rotates, the balls therefore circulate through the nut, so that the nut moves along the Y-axis direction.

This nut is fixed to a side of a lower surface of the Y-axis moving plate 18. The Y-axis moving plate 18 therefore moves together with the nut along the Y-axis direction when the screw shaft 20 is rotated by the motor 22.

On an upper surface of the Y-axis moving plate 18, a pair of X-axis guide rails 24 is fixed extending along the X-axis direction. To upper parts of the paired X-axis guide rails 24, an X-axis moving plate 26 is connected in such a manner that the X-axis moving plate 26 is slidable along the paired X-axis guide rails 24.

Between the paired X-axis guide rails 24, a screw shaft 28 is arranged extending along the X-axis direction. To one end portion of the screw shaft 28, a motor 30 is connected to rotate the screw shaft 28.

On a surface of the screw shaft 28 in which a helical groove is formed, there is disposed a nut (not depicted) that accommodates balls rolling in the groove of the rotating screw shaft 28, whereby a ball screw is constituted. When the screw shaft 28 rotates, the balls therefore circulate through the nut, so that the nut moves along the X-axis direction.

This nut is fixed to a side of a lower surface of the X-axis moving plate 26. The X-axis moving plate 26 therefore moves together with the nut in the X-axis direction when the screw shaft 28 is rotated by the motor 30.

On a side of an upper surface of the X-axis moving plate 26, a cylindrical table base 32 is arranged. On an upper part of the table base 32, a holding table 34 is disposed to hold the ingot 11. This holding table 34 has a substantially flat, circular upper surface (holding surface), and a porous plate 34a is exposed in the holding surface.

This porous plate 34a is in communication with a suction source (not depicted) such as an ejector via, for example, a communication path formed inside the holding table 34. When this suction source is operated, a suction force acts on a space in a vicinity of the holding surface of the holding table 34. When the suction source is operated with the ingot 11 placed on the holding surface, the ingot 11 is held by suction on the holding surface of the holding table 34.

The holding table 34 is connected to a rotating mechanism that includes a pulley, a motor, and the like. When this rotating mechanism is operated, the holding table 34 is rotated using, as an axis of rotation, a straight light that passes through a center of the holding surface of the holding table 34 and extends along the Z-axis direction.

In a vicinity of the horizontal moving mechanism 14, a support structure 36 having side walls substantially parallel to the Y-axis direction is disposed. On one of the side walls of the support structure 36, specifically, the side wall on a rear side in the X-axis direction (hereinafter called “the rear side wall”), a vertical moving mechanism 38 is arranged. The vertical moving mechanism 38 is fixed on the rear side wall of the support structure 36 and has a pair of Z-axis guide rails 40 extending along the Z-axis direction.

On side portions of the paired Z-axis guide rails 40, the side portions being on a side away from the support structure 36, a Z-axis moving plate 42 is connected in such a manner that the Z-axis moving plate 42 is slidable along the paired Z-axis guide rails 40. Between the paired Z-axis guide rails 40, a screw shaft (not depicted) is arranged extending along the Z-axis direction. To one end portion of this screw shaft, a motor 44 is connected to rotate the screw shaft.

On a surface of this screw shaft in which a helical groove is formed, there is disposed a nut (not depicted) that accommodates balls rolling in the groove of the rotating screw shaft, whereby a ball screw is constituted. When the screw shaft rotates, the balls therefore circulate through the nut, so that the nut moves along the Z-axis direction.

This nut is fixed to one of side walls of the Z-axis moving plate 42, the one side wall being on a side closer to the support structure 36. When the screw shaft is rotated by the motor 44, the Z-axis moving plate 42 therefore moves together with the nut along the Z-axis direction.

On the other side wall of the Z-axis moving plate 42, the other side wall being on a side away from the support structure 36, a support casing 46 is fixed. The support casing 46 is connected to the laser beam irradiation unit 48 that serves to irradiate, with a laser beam, the ingot 11 supported on the holding table 34.

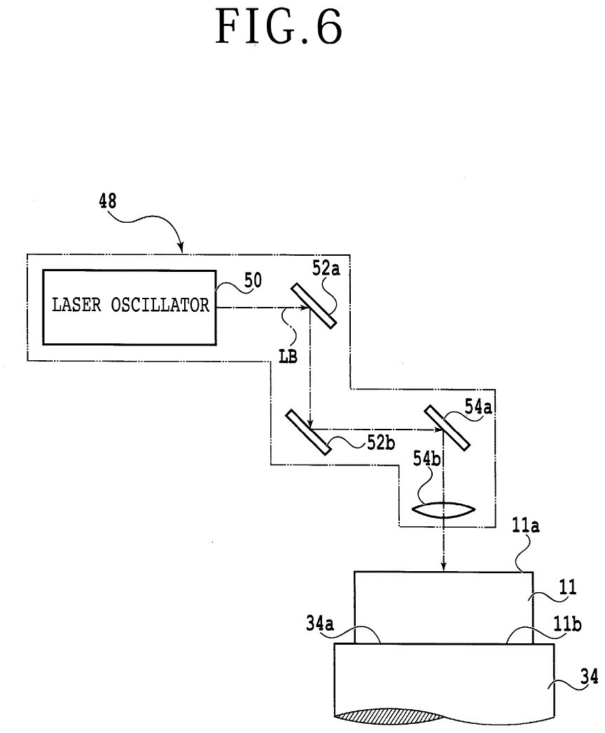

FIG. 6 is a diagram schematically presenting how a pulsed laser beam LB (hereinafter simply called “the laser beam LB”) advances inside the laser processing machine 10. It is to be noted that, in FIG. 6, some of elements of the laser beam irradiation unit 48 are presented as a block.

As depicted in FIGS. 5 and 6, the laser beam irradiation unit 48 includes, for example, a laser oscillator 50 fixed on the bed 12, a cylindrical housing 52 that is supported at a proximal end portion thereof on the support casing 46 and that extends along the Y-axis direction, and a head 54 disposed on a distal end portion of the housing 52.

The laser oscillator 50 has a laser medium suited for laser oscillation, for example, such as Nd: YAG. This laser oscillator 50 emits the laser beam LB of a wavelength (for example, 1,064 nm or 1,342 nm) having transmissivity for the material of the ingot 11.

The housing 52 accommodates some elements of an optical system that makes up the laser beam irradiation unit 48, for example, mirrors 52a and 52b presented in FIG. 6, and guides the laser beam LB, which has been emitted from the laser oscillator 50, to the head 54.

The head 54 accommodates some other elements of the optical system that makes up the laser beam irradiation unit 48, for example, a mirror 54a and a condenser lens 54b. The laser beam LB which has been guided through the housing 52 is deflected downward in its advancing path by the mirror 54a, and is then focused by the condenser lens 54b at a height corresponding to the ingot 11 held on the holding table 34.

As depicted in FIG. 5, a camera 56 is also disposed at a position adjacent in the X-axis direction to the head 54. Over the bed 12, a cover (not depicted) is disposed enclosing the above-mentioned elements. On a wall of the cover, a touch screen 58 is disposed as a user interface.

The touch screen 58 is configured, for example, by an input device such as a capacitive touch sensor or a resistive film touch sensor, and a display device such as a liquid crystal display or an organic electroluminescence (EL) display.

Operations of the respective elements of the above-mentioned laser processing machine 10 are controlled by the controller 60 built in the laser processing machine 10. This controller 60 includes a processor 60a and a memory 60b.

It is to be noted that the processor 60a is configured, for example, by a central processing unit (CPU) or the like. It is also to be noted that the memory 60b is configured, for example, by a volatile memory such as a dynamic random-access memory (DRAM) or a static random-access memory (SRAM) and a nonvolatile memory such as a solid-state drive (SSD) (NAND-type flash memory) or a hard disk drive (HDD) (magnetic storage device).

The memory 60b stores a variety of kinds of information (specifically, data, programs, and the like) to be used in the processor 60a. For example, the memory 60b stores information on optical characteristics (for example, luminance levels of multiple shades) and illumination conditions for the laser beam LB in association with each other. It is to be noted that examples of irradiation conditions for the laser beam LB include the height of a focal point at which the laser beam LB is focused, the power of the laser beam LB, the pulse pitch set according to the frequency of the laser beam LB and the moving speed of the holding table 34, and so on.

The processor 60a controls the elements of the laser processing machine 10, for example, in such a manner that programs are read from the memory 60b and executed to form a separation layer inside the ingot 11 with use of the laser beam LB.

When conducting the setting step S3 on the laser processing machine 10, the information (specifically, the data of the luminance level of the light L transmitted through each of the facet region 17a and the non-facet region 17b) acquired in the substrate evaluating step S2 is first inputted in the controller 60. When this information is inputted in the controller 60, the processor 60a then sets, for every one of the plurality of regions on the side of the one side 11a of the ingot 11, irradiation conditions for the laser beam LB based on the data stored in the memory 60b.

In the setting step S3, the irradiation conditions for the laser beam LB are set, for example, such that the laser beam LB is applied with relatively high power to a region where the measured luminance level of the light L is relatively low (specifically, the facet region 11f). Described specifically, in the setting step S3, the power levels of the laser beam LB to be applied to the facet region 11f and the non-facet region 11g are set, for example, at 10 W and 6 W, respectively.

When conducting the separation layer forming step S4 on the laser processing machine 10, the ingot 11 is first placed on the holding table 34 such that the one side 11a of the ingot 11 is directed upward and the ingot 11 covers the porous plate 34a. The suction source which is in communication with the porous plate 34a is then so operated that the ingot 11 is held by suction on the holding surface of the holding table 34.

Next, the camera 56 is operated to form an image by imaging the ingot 11. With reference to this image, the holding table 34 is then rotated, for example, such that the primary orientation flat 13 lies parallel to the Y-axis direction. Thereafter, the head 54 is moved up or down in such a manner that the focal point, at which the laser beam LB emitted from the head 54 is focused, is positioned at a predetermined depth from the one side 11a of the ingot 11.

Next, under the irradiation conditions set for every one of the plurality of regions (specifically, the facet region 11f and the non-facet region 11g) on the side of the one side 11a of the ingot 11, the ingot 11 is irradiated with the laser beam LB to form a separation layer. Described specifically, this separation layer is formed in the following order.

First, the holding table 34 is moved along the X-axis direction and/or the Y-axis direction such that a linear region (first region) of the ingot 11, the first region being located in a vicinity of one end in the Y-axis direction of the ingot 11, is positioned in the X-axis direction as seen in a plan view from the head 54. With the laser beam LB emitted from the head 54, the holding table 34 is then moved along the X-axis direction in such a manner that the focal point at which the laser beam LB is focused passes through from the one end to the other end in the X-axis direction of the ingot 11. As a consequence, a unit separation layer, which includes modified portions and cracks spreading from the modified portions, is formed in the first region of the ingot 11.

Now, the first region of the ingot 11 is assumed to be included, for example, in the non-facet region 11g in its entirety. In this case, the processor 60a controls the laser beam irradiation unit 48 in such a manner that the first region is irradiated with the laser beam LB according to the irradiation conditions set for the non-facet region 11g in the setting step S3 (for example, by setting its power at 6 W).

Next, the holding table 34 is moved along the Y-axis direction such that the head 54 is positioned in the X-axis direction as seen in the plan view from another region (second region) slightly apart in the Y-axis direction from the region already irradiated with the laser beam LB, in other words, the first region of the ingot 11. With the laser beam LB emitted from the head 54, the holding table 34 is then moved along the X-axis direction in such a manner that the focal point at which the laser beam LB is focused passes through from the other end to the one end in the X-axis direction of the ingot 11. As a consequence, another unit separation layer, which includes modified portions and cracks spreading from the modified portions, is formed in the second region of the ingot 11.

Here, the second region of the ingot 11 is also assumed to be included, for example, in the non-facet region 11g in its entirety. In this case, the processor 60a controls the laser beam irradiation unit 48 in such a manner that the second region is irradiated with the laser beam LB while maintaining the irradiation conditions set for the non-facet region 11g in the setting step S3.

Next, the holding table 34 is moved along the Y-axis direction such that a further region (third region) slightly apart in the Y-axis direction from the region already irradiated with the laser beam LB, specifically, the second region, is positioned in the X-axis direction as seen in the plan view from the head 54. The above-mentioned operations are repeated further until irradiation of a still further region in a vicinity of the other end in the Y-axis direction of the ingot 11 with the laser beam LB is completed.

It is to be noted that, if the ingot 11 is irradiated with the laser beam LB as described above, there is a timing at which the facet region 11f is irradiated with the laser beam LB during the irradiation. At this timing, the processor 60a controls the laser beam irradiation unit 48 in such a manner that the facet region 11f is irradiated with the laser beam LB according to the irradiation conditions set for the facet region 11f in the setting step S3 (for example, by setting its power at 10 W).

In the laser processing method illustrated in FIG. 2, with reference to the information on optical characteristics in every one of the plurality of regions (specifically, the facet region 11f and the non-facet region 11g) on the side of the one side 11a of the ingot 11 (for example, the data of the luminance level of the light L transmitted through each of the facet region 11f and the non-facet region 11g), the processor 60a sets, for every one of the plurality of regions, irradiation conditions for the laser beam LB for forming the separation layer inside the ingot 11. In the laser processing method, the separation layer can hence be appropriately formed inside the ingot 11.

It is to be noted that the above-mentioned laser processing method and laser processing machine are each an aspect of the present invention, and the laser processing method and the laser processing machine of the present invention are not limited to the above-mentioned details. In the laser processing method of the present invention, for example, the substrate manufacturing step S1 and/or the substrate evaluating step S2 may be conducted using the laser processing machine 10.

Described specifically, the substrate manufacturing step S1 may manufacture the substrate 17 by allowing the ingot 11 to undergo cleavage in the separation layer after using the laser processing machine 10 for forming the separation layer inside the ingot 11. Further, the substrate evaluating step S2 may be conducted using an image formed by the camera 56 imaging the substrate 17 held on the holding table 34.

The laser processing machine of the present invention may also include at least one or more of the elements of the evaluation system 2 in addition to the elements of the laser processing machine 10. For example, the laser processing machine of the present invention may also include the table 4 and the light source 6 in addition to the elements of the laser processing machine 10. If this is the case, the substrate evaluating step S2 is conducted using an image formed by placing the substrate 17 on the table 4 to position the substrate 17 right above the light source 6 and then imaging, with the camera 56, the substrate 17 with the light L being emitted upward from the light source 6.

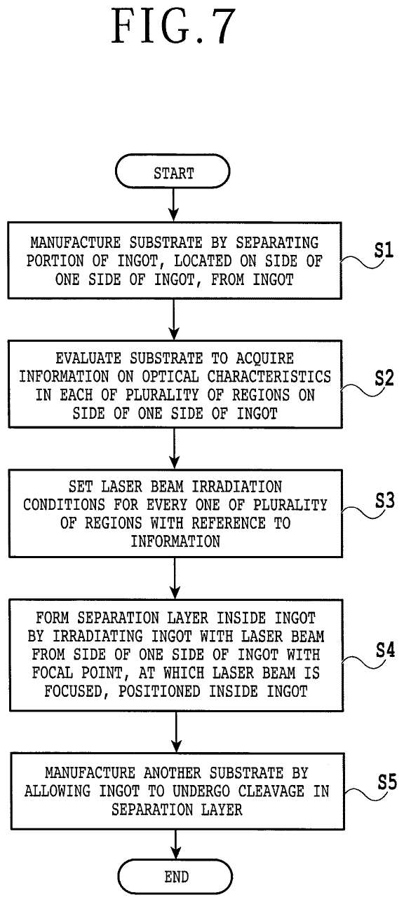

Moreover, the present invention also relates to a substrate manufacturing method that is practiced using the above-mentioned laser processing method. FIG. 7 is a flow chart schematically illustrating a substrate manufacturing method according to an embodiment of the second aspect of the present invention. In this substrate manufacturing method, the above-mentioned substrate manufacturing step (first-substrate manufacturing step) S1, substrate evaluating step (first-substrate evaluating step) S2, setting step S3, and separation layer forming step S4 are sequentially conducted.

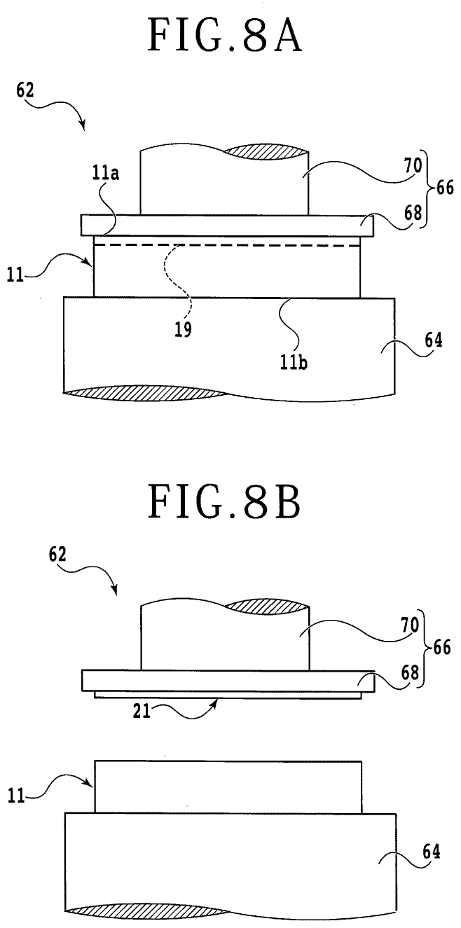

After the separation layer forming step S4, another substrate (second substrate) 21 (see FIG. 8B) is manufactured by allowing the ingot 11 to undergo cleavage in the separation layer (second-substrate manufacturing step S5). FIG. 8A is a side view schematically depicting a suction plate 68 in contact at a lower surface thereof with the one side 11a of the ingot 11, in which the separation layer has been formed for use in the manufacture of the second substrate 21, in the second-substrate manufacturing step S5, and FIG. 8B is a side view schematically depicting the second substrate 21 separated from the ingot 11 and held by suction on the suction plate 68 in the second-substrate manufacturing step S5. This second-substrate manufacturing step S5 is conducted on a separation machine 62 depicted in FIGS. 8A and 8B.

The separation machine 62 includes a holding table 64 for holding the ingot 11. This holding table 64 has a substantially flat, circular upper surface (holding surface), and a porous plate (not depicted) is exposed in the holding surface.

This porous plate is in communication with a holding table side suction source (not depicted) such as an ejector via a communication path formed inside the holding table 64. When this holding table side suction source is operated, a suction force acts on a space in a vicinity of the holding surface of the holding table 64. When the holding table side suction source is operated with the ingot 11 placed on the holding surface, the ingot 11 is held by suction on the holding surface of the holding table 64.

Above the holding table 64, a separation unit 66 is disposed. This separation unit 64 has the suction plate 68, in a lower surface of which a plurality of suction orifices are formed. These suction orifices are in communication with a separation unit side suction source such as a vacuum pump via a suction path formed inside the suction plate 68. When this separation unit side suction source is operated, a suction force acts on a space in a vicinity of the lower surface of the suction plate 68.

To an upper surface of the suction plate 68, a vertical moving mechanism 70 is connected. This vertical moving mechanism 70 has, for example, a ball screw, a motor, and the like. When the vertical moving mechanism 70 is operated, the suction plate 68 is moved along the vertical direction.

When conducting the second-substrate manufacturing step S5 on the separation machine 62, the ingot 11 is first placed on the holding table 64 such that the one side 11a of the ingot 11, in which a separation layer 19 has been formed, is directed upward and the ingot 11 covers the porous plate of the holding table 64. The holding table side suction source, which is in communication with the porous plate, is then so operated that the ingot 11 is held by suction on the holding surface of the holding table 64.

Next, the suction plate 68 is moved down in such a manner as to bring the lower surface of the suction plate 68 into contact with the one side 11a of the ingot 11 (see FIG. 8A). The separation unit side suction source is then so operated that the ingot 11 is drawn upward at the side of the one side 11a. Thereafter, the suction plate 68 is moved up in such a manner that the suction plate 68 is moved apart from the holding table 64 (see FIG. 8B).

Accordingly, the ingot 11 is applied with such an external force that the side of the one side 11a and the side of the other side 11b of the ingot 11 are separated from each other, whereby cracks included in the separation layer 19 are allowed to spread further. As a result, the ingot 11 is allowed to undergo cleavage in the separation layer 19, so that the second substrate 21 different from the first substrate 17 manufactured in the substrate manufacturing step (first-substrate manufacturing step) S1 is manufactured.

It is to be noted that the separation machine 62 may also be used to have the substrate 21 moved apart from the ingot 11 by drawing upward the substrate 21 that has already been separated from the ingot 11 but rests on the ingot 11.

No limitation is imposed on the thickness of the first substrate 17 to be manufactured in the first-substrate manufacturing step S1. In the first-substrate manufacturing step S1, the first substrate 17 is manufactured, for example, with a thickness equivalent to that of the second substrate 21. This is preferred in that not only the second substrate 21 but also the first substrate 17 can be used for the manufacture of chips.

As an alternative, in the first-substrate manufacturing step S1, the first substrate 17 may be manufactured with a thickness equal to or smaller than ½ times, preferably ¼ times, more preferably ⅛ times that of the second substrate 21. This is preferred in that the volume of a portion of the ingot 11, which is to be discarded without being used in manufacturing chips, can be reduced.

The second-substrate manufacturing step S2 may be conducted in any appropriate manner. In the second-substrate manufacturing step S2, such an external force may be applied, for example, by driving a wedge into the separation layer 19 from the side surface of the ingot 11, that the side of the one side 11a and the side of the other side 11b of the ingot 11 are split.

The laser processing machine of this invention may also include at least one or more elements of the separation machine 62 in addition to the elements of the laser processing machine 10. For example, the laser processing machine of the present invention may also have the separation unit 66 in addition to the elements of the laser processing machine 10. If this is the case, the second-substrate manufacturing step S2 may be conducted on the laser processing machine that has the separation unit 66.

Moreover, the constructions, methods, and the like according to the above-described embodiments can be practiced with changes or modifications made as appropriate insofar as not departing from the object of the present invention.

The present invention is not limited to the details of the above-described preferred embodiments. The scope of the invention is defined by the appended claims and all changes and modifications as fall within the equivalence of the scope of the claims are therefore to be embraced by the invention.

What is claimed is:

1. A laser processing method for forming a separation layer inside an ingot by using a laser beam of a wavelength having transmissivity for a material of the ingot, comprising:
a substrate manufacturing step of manufacturing a substrate by separating a portion of the ingot, the portion being located on a side of one side of the ingot, from the ingot;
a substrate evaluating step of, after the substrate manufacturing step, evaluating the substrate to acquire information on optical characteristics in each of a plurality of regions on the side of the one side of the ingot;
a setting step of, after the substrate evaluating step, setting, for every one of the plurality of regions, irradiation conditions for the laser beam with reference to the information; and
a separation layer forming step of, after the setting step, forming the separation layer inside the ingot by irradiating the ingot with the laser beam from the side of the one side with a focal point at which the laser beam is focused positioned inside the ingot.

2. The laser processing method according to claim 1, wherein, with the substrate irradiated with light, luminance of the light transmitted through the substrate is measured in the substrate evaluating step.

3. A substrate manufacturing method for manufacturing substrates from an ingot by using a laser beam of a wavelength having transmissivity for a material of the ingot, comprising:
a first-substrate manufacturing step of manufacturing a first substrate by separating a portion of the ingot, the portion being located on a side of one side of the ingot, from the ingot;
a first-substrate evaluating step of, after the first-substrate manufacturing step, evaluating the first substrate to acquire information on optical characteristics in each of a plurality of regions on the side of the one side of the ingot;
a setting step of, after the first-substrate evaluating step, setting, for every one of the plurality of regions, irradiation conditions for the laser beam with reference to the information;
a separation layer forming step of, after the setting step, forming a separation layer inside the ingot by irradiating the ingot with the laser beam from the side of the one side with a focal point at which the laser beam is focused positioned inside the ingot; and
a second-substrate manufacturing step of, after the separation layer forming step, manufacturing a second substrate by allowing the ingot to undergo cleavage in the separation layer.

4. A laser processing machine for forming a separation layer inside an ingot by using a laser beam of a wavelength having transmissivity for a material of the ingot, comprising:
a holding table configured to hold the ingot thereon;
a laser beam irradiation unit configured to irradiate the ingot held on the holding table with the laser beam from a side of one side of the ingot; and
a controller configured to control the laser beam irradiation unit,
wherein the controller has
a memory configured to store information on optical characteristics and irradiation conditions for the laser beam in association with each other, and
a processor configured to control the laser beam irradiation unit in such a manner that, after setting the irradiation conditions for every one of a plurality of regions for the formation of the separation layer inside the ingot with reference to information on optical characteristics acquired by evaluation of a substrate manufactured by separating a portion of the ingot, the portion being located on the side of the one side of the ingot, from the ingot, the every one of the plurality of regions is irradiated with the laser beam according to the irradiation conditions set for every one of the plurality of regions.

5. The laser processing machine according to claim 4, further comprising:
a separation unit configured to manufacture the substrate by allowing the ingot to undergo cleavage in the separation layer.
